(19) United States
(12) Patent Application Publication
(10) Pub. No.: US 2026/0138422 A1
(43) Pub. Date: May 21, 2026

(54) VEHICLE AIR VENT

(71) Applicant: Faurecia Interieur Industrie, Nanterre (FR)

(72) Inventors: Romeo TAVARES, TAVERNY (FR); Prashant KUMAR, FRANCONVILLE LA GARENNE (FR)

(21) Appl. No.: 19/389,493

(22) Filed: Nov. 14, 2025

(30) Foreign Application Priority Data
Nov. 19, 2024 (FR) FR 24 12615

(51) Int. Cl. B60H 1/34

(52) U.S. Cl. CPC B60H 1/3435

(57) ABSTRACT

An air vent that includes: an aeration duct extending along a main axis and defined by a first internal surface; an outlet portion, defined by a second internal surface, continuous with the first internal surface of the duct; a central element, arranged in the duct along the main axis; and a plurality of longitudinal walls arranged in the duct, parallel to the main axis; each longitudinal wall extending radially between the central element and the first internal surface of the duct. The central element and the longitudinal walls are fixed relative to the duct. The second internal surface has a transverse dimension that decreases starting from the first internal surface of the duct.

### TECHNICAL FIELD

The present invention relates to an air vent of the type comprising: an aeration duct extending along a main axis and defined by a first internal surface, preferentially axisymmetrical; an outlet portion, defined by a second internal surface, arranged along the main axis and continuous with the first internal surface of the duct; a central element, arranged in the duct along the main axis; and a plurality of longitudinal walls arranged in the duct, parallel to the main axis; each longitudinal wall extending radially between the central element and the first internal surface of the duct; the central element and the longitudinal walls being preferentially fixed relative to the duct.

### BACKGROUND

The invention applies particularly to air vents intended to equip a passenger compartment of a vehicle, in particular of a motor vehicle. Such an air vent is described in particular in document FR2948752.

It is known to modulate the orientation of the air leaving the air vent by means of moving elements of the louver type. However, such devices may be fragile and produce unwanted noise during operation.

### SUMMARY

An aim of the invention is to offer an air vent without a visible moving element at the air vent outlet.

To this end, the invention relates to an air vent of the aforementioned type, wherein the second internal surface has a transverse dimension that decreases starting from the first internal surface of the duct.

According to other advantageous aspects of the invention, the air vent comprises one or more of the following features, taken alone or in any technically feasible combinations:
the second internal surface of the outlet portion forms a first angle, of between 30°and 60°, with the main axis, said first angle preferentially being close to 45°;
the central element comprises first and second external surfaces, adjacent along the main axis; a junction between the first and second external surfaces having a maximum transverse dimension of the central element, perpendicular to the main axis; each of the first and second external surfaces presenting a transverse dimension that decreases starting from said junction;
the first external surface of the central element is oriented towards the outlet portion and has a frustoconical shape, said first external surface forming a second angle, between 30° and 60°, with the main axis;
the first and second angles are substantially equal;
the second external surface of the central element is oriented away from the outlet portion and has a frustoconical shape, said first external surface forming a third angle, of between 30° and 60°, with the main axis;
the third angle is smaller than the second angle;
the air vent further comprises a deflector arranged in the outlet portion, the deflector comprising an annular wall arranged around the main axis, the annular wall having a frustoconical shape and forming a fourth angle, of between 30° and 60°, with the main axis;
the first and fourth angles are substantially equal;
the plurality of longitudinal walls delimits a plurality of distinct channels;
the outlet portion comprises an open downstream end, defining an air vent outlet; the air vent comprises: a first free jet zone, defined as a projection of a first annular volume, comprised between the central element and the deflector; and/or a second free jet zone, defined as a projection of a second annular volume, comprised between the deflector and the downstream end of the outlet portion; and the air vent is configured so that a sum of the first and second free jet zones is less than or equal to 5% of an area defined by the downstream end of the outlet zone.

The invention further relates to a ventilation assembly, comprising an air vent as described above and at least one member for supplying air to the various channels, said at least one supply member being arranged in the air vent or in ducts directing air to the air vent.

The invention further relates to a vehicle, particularly a motor vehicle, equipped with an air vent and/or ventilation assembly as described above.

### BRIEF DESCRIPTION OF THE DRAWINGS

The invention will become clearer on reading the following description, given solely by way of non-limiting example, and made with reference to the drawings, wherein:

FIG. 1 is a front view of an air vent according to one embodiment of the invention;

FIG. 2 is a longitudinal cross-sectional view of the air vent of FIG. 1; and

FIG. 3 is a transverse cross-sectional view of the air vent of FIGS. 1 and 2.

### DETAILED DESCRIPTION

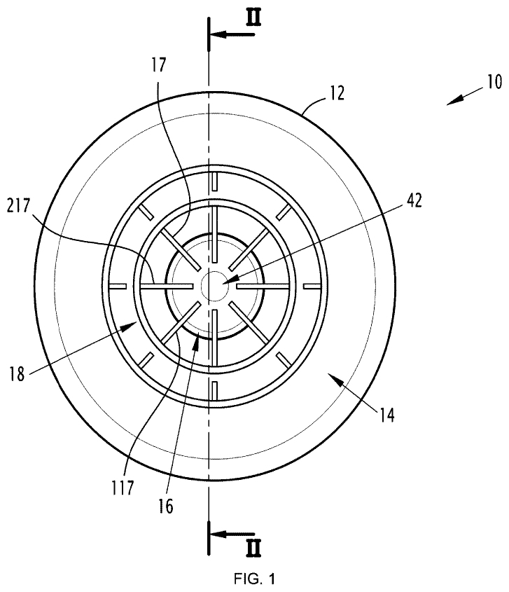

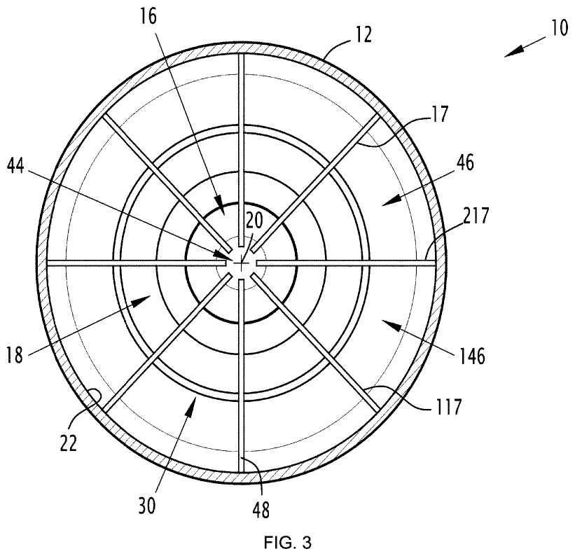

FIGS. 1 and 3 show an air vent 10 according to a first embodiment of the invention. In the embodiment shown, the air vent 10 is installed in a vehicle passenger compartment (not shown), preferably in a motor vehicle passenger compartment.

The air vent 10 comprises in particular: an aeration duct 12; an outlet portion 14; a central element 16; and a plurality of longitudinal walls 17, 117, 217. In the embodiment shown, the air vent further comprises a deflector 18.

The aeration duct 12 extends along a main axis 20 and comprises a first internal surface 22, arranged around said main axis 20. Preferentially, the first internal surface 22 is axisimetric; more preferentially, the first internal surface 22 is substantially cylindrical. In the embodiment shown, the first internal surface 22 is rotationally cylindrical and has a first diameter 24.

In the embodiment shown, the duct 12 comprises a downstream section 26 and an upstream section 28, adjacent to each other along the main axis 20. The downstream 26 and upstream 28 sections are described in greater detail below.

The outlet portion 14 is formed in one piece with the aeration duct 12. The outlet portion 14 is defined by a second internal surface 30, arranged along the main axis and continuous with the first internal surface 22 of the duct 12. More precisely, the outlet portion 14 extends between an upstream end 31, adjacent to the duct 12, and an open downstream end 32.

The second internal surface 30 has a transverse dimension that decreases between the upstream 31 and downstream 32 ends of the outlet portion 14.

In the embodiment shown, the second internal surface 30 is frustoconical. A second diameter 34 of said second internal surface 30, at the downstream end 32, is smaller than the first diameter 24.

The second internal surface 30 of the outlet portion 14 forms a first angle α, between 30° and 60°, with the main axis 20. Preferably, said first angle α is approximately 45°.

The central element 16 is arranged in the duct 12 and extends along the main axis 20.

As described below, the central element 16 is configured to promote air circulation in the duct 12. Preferably, the central element 16 comprises first and second external surfaces 36, 38, adjacent along the main axis 20. A junction 40 between said first and second external surfaces presents a maximum transverse dimension of the central element, perpendicular to the main axis 20. Each of the first and second external surfaces 36, 38 has a decreasing transverse dimension from said junction 40.

The first external surface, or downstream surface 36 of the central element 16, faces the outlet portion 14. In the embodiment shown, a downstream end 42 of said downstream surface 36, opposite the junction 40, is substantially coplanar with the upstream end 31 of said outlet portion 14.

In the embodiment shown, the downstream surface 36 of the central element 16 has a frustoconical shape, arranged around the main axis 20. The downstream surface 36 forms a second angle β, between 30° and 60°, with the main axis 20. Preferably, the second angle β is substantially equal to the first angle α described above.

The second outer surface, or upstream surface 38 of the central element 16, faces away from the outlet portion 14. In the embodiment shown, the upstream surface 38 of the central element 16 has a frustoconical shape, arranged around the main axis 20. The upstream surface 38 forms a third angle γ, between 30° and 60°, with the main axis 20. In the embodiment shown, the third angle γ is smaller than the second angle β described above. For example, the third angle γ is about half the size of the second angle.

Preferably, an upstream end 44 of the central element 16 has a domed shape.

Longitudinal walls 17, 117, 217 are arranged in the duct, parallel to the main axis 20. Each longitudinal wall 17, 117, 217 extends radially between the central element 16 and the first internal surface 22 of the conduit. More specifically, each longitudinal wall 17, 117, 217 is attached to both the central element and the first internal surface 22 of the conduit. Thus, the central element 16 and the longitudinal walls 17, 117, 217 are fixed relative to the duct 12.

Preferentially, each longitudinal wall 17, 117, 217 is substantially flat and extends in a plane containing the main axis 20. More preferentially, the longitudinal walls 17, 117, 217 are evenly angularly distributed around the main axis 20.

Longitudinal walls 17, 117, 217 delimit a plurality of channels 46, 146 in the duct 12.

The air vent 10 preferentially comprises at least two longitudinal walls, more preferentially at least three longitudinal walls 17, 117, 217. In the embodiment shown, the air vent 10 comprises eight longitudinal walls delimiting eight channels 46, 146 of comparable dimensions.

In the embodiment shown, each longitudinal wall 17, 117, 217 has a substantially straight upstream end 48, with the upstream ends 48 of the longitudinal walls 17, 117, 217 lying in a plane perpendicular to the main axis 20. Said upstream ends 48 mark a boundary between the downstream part 26 and the upstream part 28 of the duct 12, the longitudinal walls 17, 117, 217 and the channels 46, 146 being arranged in the downstream part 26.

In an embodiment not shown, the upstream ends 48 of the longitudinal walls 17, 117, 217 are arranged at the upstream end of the upstream part 28.

In the embodiment shown, each longitudinal wall 17, 117, 217 further comprises a downstream portion 50, 150 which extends into the outlet portion 14, in contact with the second internal surface 30.

Preferably, each downstream portion 50, 150 has a substantially straight downstream end 52, extending between the downstream surface 36 of the central element 16 and the second internal surface 30. Each downstream end 52 forms a fourth angle δ with the main axis. Preferably, the fourth angle δ is substantially equal to the first α and/or second β angle described above.

The deflector 18 is arranged in the outlet portion 14 and is formed by an annular wall arranged around the main axis 20, between a downstream end 54 and an upstream end 56. In the embodiment shown, the upstream end 56 of the deflector 18 is integral with the downstream portions 50, 150 of the longitudinal walls 17, 117, 217; and the downstream end 54 projects from the downstream ends 52 of said downstream portions 50, 150.

Preferably, the deflector 18 has a truncated cone shape and forms a fifth angle θ, of between 30° and 60°, with the main axis 20. The outlet portion 14 thus comprises an internal passage 60 and an external passage 62, arranged between the deflector 18 and, respectively, the downstream surface 36 of the central element 16 and the second internal surface 30 of the outlet portion 14.

In the embodiment shown, the first α, second β and fifth θ angles are equal. The internal passage 60 thus has a constant transverse dimension between the upstream end 56 of the deflector 18 and the downstream end 42 of the downstream surface 36 of the central element 16. Similarly, the external passage 62 has a constant transverse dimension between the upstream 56 and downstream 54 ends of the deflector 18.

In the embodiment shown, we consider a first free jet zone 64, defined as the projection, on a plane perpendicular to the main axis 20, of an annular volume extending along said main axis and comprised between the central element 16 and the deflector 18.

A second free jet zone (not shown) is also considered, defined as the similar projection of an annular volume between the deflector 18 and the downstream end 32 of the outlet zone 14. In the embodiment shown, the second free jet zone is absent.

Preferably, the air vent 10 is configured with one or more free jet zones of reduced size. More precisely, the air vent 10 is preferentially configured so that the sum of the areas of the first 64 and second free jet zones is less than or equal to 5% of an area perpendicular to the main axis 20 and defined by the downstream end 32 of the outlet zone 14. Such a configuration favors good airflow directivity at the outlet of the air vent 10.

Optionally, the air vent 10 is configured to supply the plurality of channels 46, 146 with air flows independent of each other. For example, the air vent 10 comprises feed tubes 66, 166 (shown dotted) extending into the upstream part 28 of the aeration duct 12, each feed tube 66, 166 being connected to a separate channel 46, 146, delimited by the longitudinal walls 17, 117, 217.

Preferably, the air vent 10 is integrated into a vehicle interior (not shown) so that the outlet portion 14 is flush with or protrudes into said interior and the ventilation duct 12 is concealed by a wall of said interior. As a result, the air vent 10 comprises no moving parts visible from inside the passenger compartment.

A method for using the air vent 10 will now be described.

The supply tubes 66, 166 are fed by air streams that are preferentially separate from each other. As will be explained below, this separation of air flows at the inlet to the air vent 10 enables the overall air flow at the outlet to be oriented.

In a variant not shown, the air vent comprises a device for selectively blocking channels 46, 146. Such a sealing device is preferably located close to the upstream ends 48 of the longitudinal walls 17, 117, 217.

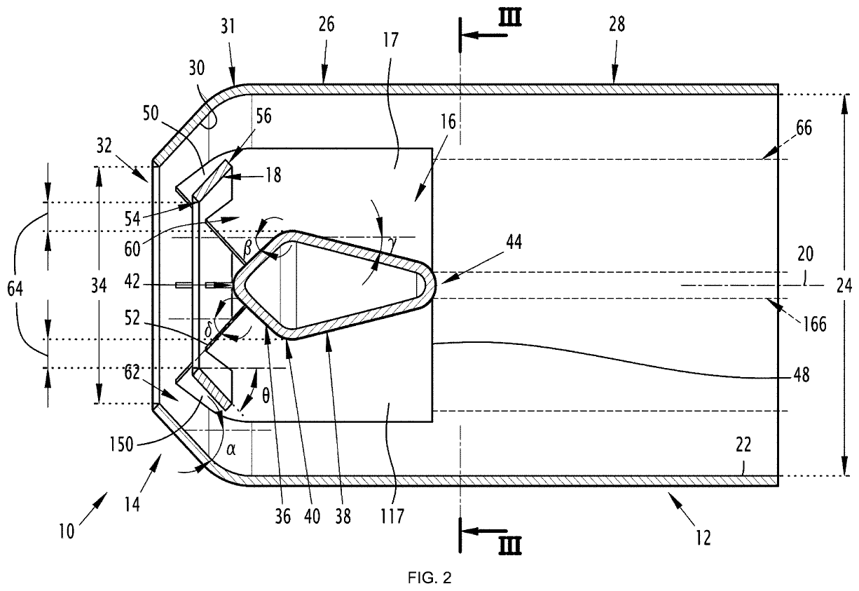

In one embodiment, similar air flows are sent to at least two of the channels 46, 146. For example, in the embodiment shown in FIGS. 1 to 3, similar air flows are preferentially sent to two adjacent channels 46, 146.

The frustoconical shape of the outlet portion 14, the central element 16 and the deflector 18 convergently directs and orients the air flows coming from the channels 46, 146.

The orientation of an overall outlet flow, at the downstream end 32 of the air vent 10, depends on the supply to the various channels 46, 146 according to their arrangement around the main axis 20.

In this way, it is possible to direct the air flow at the outlet of air vent 10 without using moving parts such as vanes. This reduces unwanted noise and improves the wear resistance of the device.

The similar angles between the outlet portion 14, the central element 16 and the deflector 18 minimize turbulence at the air vent outlet.

1. An air vent comprising:
an aeration duct extending along a main axis and defined by a first axisymmetric internal surface;
an outlet portion is defined by a second internal surface, arranged along the main axis and continuous with the first internal surface of the duct;
a central element, arranged in the duct along the main axis; and
a plurality of longitudinal walls arranged in the duct, parallel to the main axis; each longitudinal wall extending radially between the central element and the first internal surface of the duct;
the central element and the longitudinal walls being fixed relative to the duct;
wherein the second internal surface has a transverse dimension that decreases starting from the first internal surface of the duct.

2. The air vent according to claim 1, wherein the second internal surface of the outlet portion forms a first angle, between 30° and 60°, with the main axis.

3. The air vent according to claim 1, wherein the central element comprises first and second external surfaces, adjacent along the main axis; a junction between the first and second external surfaces having a maximum transverse dimension of the central element, perpendicular to the main axis; each of the first and second external surfaces presenting a transverse dimension that decreases starting from said junction.

4. The air vent according to claim 3, wherein the first external surface of the central element is oriented towards the outlet portion and has a frustoconical shape, said first external surface forming a second angle, between 30° and 60°, with the main axis.

5. The air vent according to claim 4, wherein the first and second angles are substantially equal.

6. The air vent according to claim 1, further comprising a deflector arranged in the outlet portion, the deflector comprising an annular wall arranged around the main axis, the annular wall having a frustoconical shape and forming a fourth angle, of between 30° and 60°, with the main axis.

7. The air vent according to claim 6, wherein the first and fourth angles are substantially equal.

8. The air vent according to claim 1, wherein the plurality of longitudinal walls delimit a plurality of distinct channels.

9. The air vent according to claim 6, wherein:
the outlet portion comprises an open downstream end, defining an air vent outlet;
the air vent comprises: a first free jet zone, defined as a projection of a first annular volume, comprised between the central element and the deflector; and/or a second free jet zone, defined as a projection of a second annular volume, comprised between the deflector and the downstream end of the outlet portion; and
the air vent is configured so that a sum of the first and second free jet zones is less than or equal to 5% of an area defined by the downstream end of the outlet zone.

10. A ventilation assembly, comprising: an air vent according to claim 8; and at least one member for supplying air to the channels, said at least one supply member being arranged in the air vent or in ducts directing air to the air vent.

11. The air vent according to claim 4, wherein said first angle is approximately 45°.
